(19) United States
(12) Patent Application Publication
(10) Pub. No.: US 2013/0096901 A1
(43) Pub. Date: Apr. 18, 2013

(54) Verifying Simulation Design Modifications

(71) Applicants: Wolfgang Gellerich, Boeblingen (DE); Guenter Mayer, Schoenaich (DE); Chung-Lung K. Shum, Wappingers Falls, NY (US); Kai Weber, Holzgerlingen (DE)

(72) Inventors: Wolfgang Gellerich, Boeblingen (DE); Guenter Mayer, Schoenaich (DE); Chung-Lung K. Shum, Wappingers Falls, NY (US); Kai Weber, Holzgerlingen (DE)

(73) Assignee: International Business Machines Corporation, Armonk, NY (US)

(21) Appl. No.: 13/271,472

(22) Filed: Oct. 12, 2011

(51) Int. Cl. G06F 17/50

(52) U.S. Cl. 703/13

(57) ABSTRACT

A mechanism is provided for verifying design modifications to a simulation design unit included within a simulation model of an integrated electronic device. A modified description is received of a simulation design unit that failed to meet an expected physical property value during an initial simulation of the entire integrated electronic device. A simulation of the simulation design unit is executed using a list of identified input signals from a trace file. The trace file is generated during the initial simulation and indicates state values for the list of identified input signals. A determination is made as to whether the simulation of the simulation design unit fails to meet the expected physical property value. An indication is generated that modifications made to an initial description of the simulation design unit are successful in response to the simulation of the simulation design unit meeting the expected physical property value.

### BACKGROUND

The present application relates generally to an improved data processing apparatus and method and more specifically to mechanisms for verifying design modifications to a device design in a simulation environment.

Simulation environments are used for quality assurance during product design verification. Simulation enables identification of design problems prior to building a physical prototype and provides insight into logical and physical properties of a device's design. Simulating complex systems consumes significant time and processing resources.

Simulation is particularly important in the design of integrated electronic devices, such as computer processors, application specific integrated circuits (ASICs), and the like. Processor(s) are often designed using a specification language with the resulting processor specification being used as a basis for producing the resulting integrated circuit chips comprising the processor(s). To verify that the processor design is correct, a simulator executes a translated representation of the processor specification. The simulation allows for the testing of the behavior of the processor against an expected behavior to determine if the processor design is performing as desired.

Design verification of integrated electronic devices using a simulator covers logical as well as physical properties. The term “logical” refers to the input to an integrated electronic device causing an expected output. However, possible problems in a design of the integrated electronic device may also include “physical” properties such as heat generation, cooling, and issues related to the distribution of electrical power within the integrated electronic device, i.e. properties concerning the physical operation of the elements comprising the integrated electronic device.

Simulations usually reveal problems in the design of the integrated electronic device and, after the identified problems have been addressed by a developer, the simulation of the entire integrated electronic device is run again to verify that the identified (problems have been solved. Moreover, the subsequent simulation may identify whether the solution generated by the developer has introduced any new design problems requiring further modification of the design.

### SUMMARY

In one illustrative embodiment, a method, in a data processing system, is provided for verifying design modifications to a simulation design unit included within a simulation model of an integrated electronic device. The illustrative embodiment receives a modified description of the simulation design unit that failed to meet an expected physical property value during an initial simulation of the entire integrated electronic device. The illustrative embodiment executes a simulation of the simulation design unit using a list of identified input signals from a trace file. In the illustrative embodiment, the trace file is generated during the initial simulation of the entire integrated electronic device, and indicates state values for the list of identified input signals. The illustrative embodiment determines whether the simulation of the simulation design unit fails to meet the expected physical property value. Responsive to the simulation of the simulation design unit meeting the expected physical property value, the illustrative embodiment generates an indication that modifications made to an initial description of the simulation design unit are successful.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment,

These and other features and advantages of the present invention will be described in, or will become apparent to those of ordinary skill in the art in view of the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example block diagram of a data processing system in which aspects of the illustrative embodiments may be implemented;

FIG. 2 depicts an exemplary block diagram of a conventional dual threaded processor design showing functional units and registers in accordance with an illustrative embodiment;

FIG. 3 depicts a functional block diagram of a simulation environment in accordance with an illustrative embodiment;

FIG. 4 depicts a flow diagram of the process performed by a simulation mechanism in simulation of the execution of an integrated electronic device in accordance with an illustrative embodiment;

FIG. 5 depicts a flow diagram of the process performed by a simulation mechanism in simulation of the re-execution of a unit in a plurality of units within an integrated electronic device in accordance with an illustrative embodiment; and

FIG. 6 is a flow diagram of a design process used in semiconductor design, manufacture, and/or test.

### DETAILED DESCRIPTION

The illustrative embodiments provide a mechanism for verifying design modifications to a device design in a simulation environment. State-of-the-art integrated electronic devices comprise several operational units, for example, execution units, decode units, sequencer units, fetch units, or the like. Verifying logical properties of such units requires simulation of the behavior of all involved units. However, verification of physical properties, such as heat generation, power consumption, and the like, of a single unit may be performed in isolation. That is, assuming that a simulation of the integrated electronic device reveals that only one unit within the integrated electronic device exceeds a physical property metric, a solution for this problem may be to rearrange the topology of that part of the integrated electronic device or to allow more space within the integrated electronic device around the unit. Other possible problem solutions may include clock gating or other modifications in the logic design. Currently, verifying that the problem is indeed solved is performed by re-executing the simulation of the whole integrated electronic &vice design which is a time consuming process and typically takes a large amount of computation time. However, given that the problem affected a physical property of a particular unit allows for a more efficient verification using the mechanisms of the illustrative embodiments as described hereafter.

In the illustrative embodiments, during an initial simulation of an integrated electronic device, data representing signals from and to the different parts of the integrated electronic device are written to a trace file. In many cases, writing data representing all signals from and to the different parts of the integrated electronic device to a trace file may always be performed because such information forms the basis for understanding functional problems as well. However, in order to validate the correctness for a solution for physical property violations, only the behavior of the respective unit that violated the physical property needs to be simulated. During verification of modifications to the design of the unit that violated a design criteria associated with a physical property, as identified through simulation of the integrated device design, only the data representing the signals needed to drive the respective unit are obtained from the trace file and input into the simulator. This, in effect, causes a “limited simulation” to be run only on the unit that was determined to have violated the design criteria for the physical property. Estimated physical values obtained from running the limited simulation are then compared to the expected physical property values to verify whether the modification to the design of the unit resolved the physical property violation.

The effort for performing a subsequent simulation is thus reduced from having to simulate the entire integrated electronic device design again to only having to simulate the modified unit in order to verify that the modifications solved the prior physical property violations detected in the previous simulation. All remaining parts of the integrated electronic device do not need to be simulated. The signals these units would generate are assumed to have not changed because no logical pr physical changes have been made to other portions of the integrated electronic device.

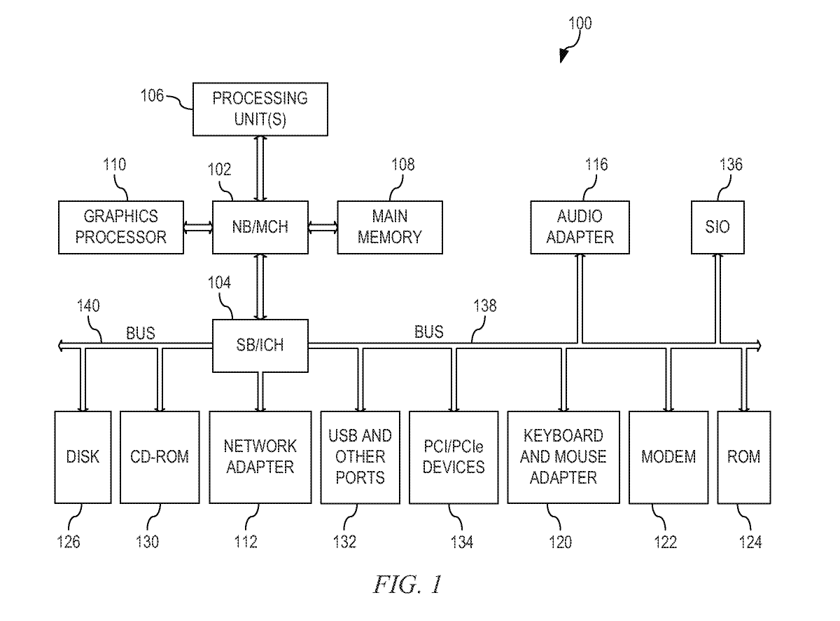

It should be appreciated that the illustrative embodiments may be utilized in many different types of data processing environments including distributed data processing systems, stand alone data processing systems, and the like. In order to provide a context for the description of the specific elements and functionality of the illustrative embodiments, FIG. 1 is provided hereafter as an example environment in which aspects of the illustrative embodiments may be implemented. It should be appreciated that FIG. 1 is only an example and is not intended to assert or imply any limitation with regard to the environments in which aspects or embodiments of the present invention may be implemented. Many modifications to the depicted environment may be made without departing from the spirit and scope of the present invention.

With reference now to FIG. 1, a block diagram of an example data processing system is shown in which aspects of the illustrative embodiments may be implemented. Data processing system 100 is an example of a computing system in which computer usable code or instructions implementing the processes for illustrative embodiments of the present invention may be located or in which hardware logic or a combination of hardware logic and computer usable code/instructions may be provided for implementing the various aspects of the illustrative embodiments described hereafter, or equivalents thereof.

In the depicted example, data processing system 100 employs a hub architecture including north bridge and memory controller hub (NB/MCH) 102 and south bridge and input/output (I/O) controller hub (SB/ICH) 104. Processing unit 106, main memory 108, and graphics processor 110 are connected to NB/MCH 102. Graphics processor 110 may be connected to NB/MCH 102 through an accelerated graphics port (AGP).

In the depicted example, local area network (LAN) adapter 112 connects to SB/ICH 104. Audio adapter 116, keyboard and mouse adapter 120, modem 122, read only memory (ROM) 124, hard disk drive (HDD) 126, CD-ROM drive 130, universal serial bus (USB) ports and other communication ports 132, and PCI/PCIe devices 134 connect to SB/ICH 104 through bus 138 and bus 140. PCI/PCIe devices may include, for example, Ethernet adapters, add-in cards, and PC cards for notebook computers. PCI uses a card bus controller, white PCIe does not. ROM 124 may be, for example, a flash basic input/output system (BIOS).

HDD 126 and CD-ROM drive 130 connect to SB/ICH 104 through bus 140. HDD 126 and CD-ROM drive 130 may use, for example, an integrated drive electronics (IDE) or serial advanced technology attachment (SATA) interface. Super I/O (SIO) device 136 may be connected to SB/ICE 104.

An operating system runs on processing unit 106. The operating system coordinates and provides control of various components within the data processing system 100 in FIG. 1. As a client, the operating system may be a commercially available operating system such as Microsoft Windows 7 (Microsoft and Windows are trademarks of Microsoft Corporation in the United States, other countries, or both). An Object-oriented programming system, such as the Java programming system, may run in conjunction with the operating system and provides calls to the operating system from Java programs or applications executing on data processing system 100 (Java is a trademark of Oracle and/or its affiliates.).

As a server or alternatively as another client, data processing system 100 may be, for example, an IBM® eServer™ System p® computer system, running the Advanced Interactive Executive (AIX®) operating system or the LINUX operating system (IBM, eServer, System p, and AIX are trademarks of International Business Machines Corporation in the United States, other countries, or both, and LINUX is a registered trademark of Linus Torvalds in the United States, other countries, or both). Data processing system 100 may be a symmetric multiprocessor (SNIP) system including a plurality of processors in processing unit 106. Alternatively, a single processor system may be employed.

Instructions for the operating system, the object-oriented programming system, and applications or programs are located on storage devices, such as HDD 126, and may be loaded into main memory 108 for execution by processing unit 206. A bus system, such as bus 138 or bus 140 as shown in FIG. 1, may be comprised of one or more buses. Of course, the bus system may be implemented using any type of communication fabric or architecture that provides for a transfer of data between different components or devices attached to the fabric or architecture. A communication unit, such as modem 122 or network adapter 112 of FIG. 1, may include one or more devices used to transmit and receive data. A memory may be, for example, main memory 108, ROM 124, or a cache such as found in NB/MCH 102 in FIG. 1.

Those of ordinary skill in the art will appreciate that the hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. Also, the processes of the illustrative embodiments may be applied to a multiprocessor data processing system without departing from the spirit and scope of the present invention.

Moreover, the data processing system 100 may take the form of any of a number of different data processing systems including client computing devices, server computing devices, a tablet computer, laptop computer, telephone or other communication device, a personal digital assistant (PDA), or the like. In some illustrative examples, data processing system 100 may be a portable computing device which is configured with flash memory to provide non-volatile memory for storing operating system files and/or user-generated data, for example. Essentially, data processing system 100 may be any known or later developed data processing system without architectural limitation.

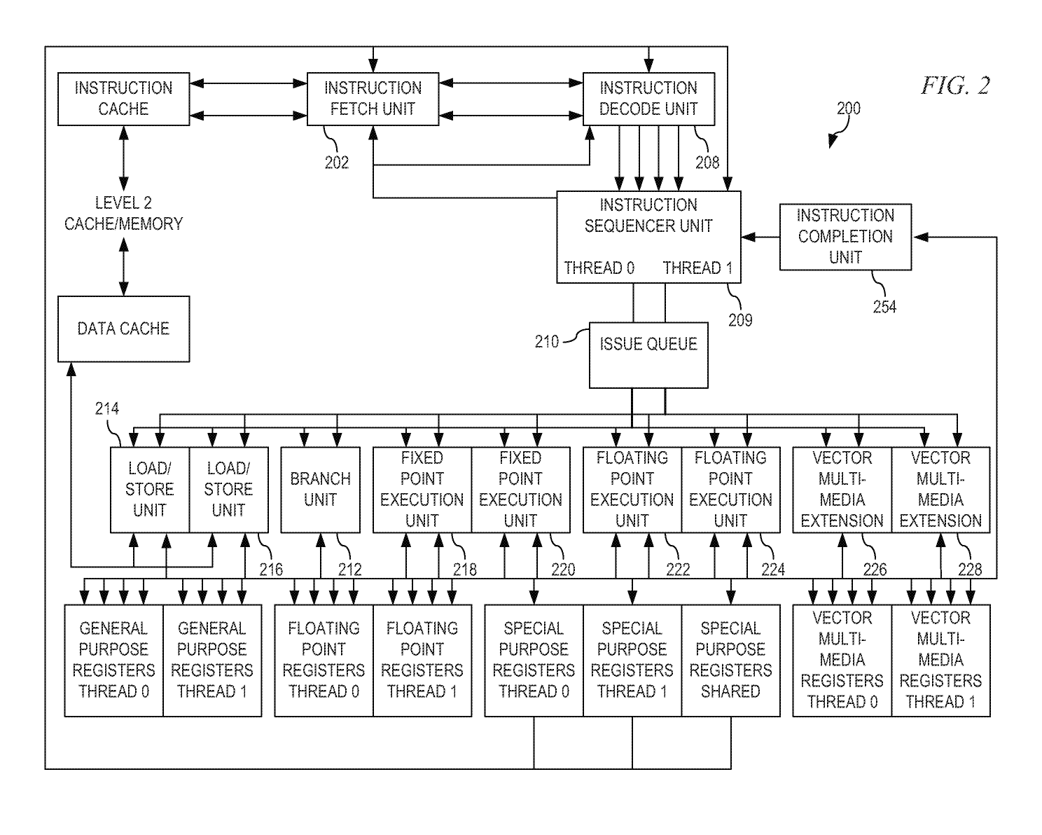

Again, the illustrative embodiments provide a mechanism for verifying design modifications to a device design in a simulation environment. FIG. 2 provides one example of an integrated electronic device which may be simulated in a simulation environment in accordance with an illustrative embodiment. An integrated electronic device, such as conventional dual threaded processor 200 of FIG. 2, comprises several units with various signals connecting the units. These units may have one or more non-functional properties which may or may not be related to the value of the signals. That is, units such as instruction fetch unit (IFU) 202, instruction decode unit 208, instruction sequencer unit (ISU) 209, execution units 212, 214, 216, 218, 220, 222, 224, 226, and 228, instruction completion unit 254, or the like, of processor 200 may have one or more non-functional properties which may or may not be related to the value of the signals processed by the units. Again, a non-functional property is a property such as heat generation, cooling, power consumption, issues related to the distribution of electrical power within the design, or the like.

An integrated electronic device may be simulated on a simulator, such as data processing system 200 of FIG. 2, using an initial description of the integrated electronic device such that values are computed for the one or more physical properties, which are then reported and/or stored, and then are compared with expected values. If after the initial simulation, one or more units have one or more physical properties that fail to meet expected physical property values, a modified description for the integrated electronic device is provided. A second or limited simulation is then performed only for those units that violated physical property metrics. During this second simulation, the values for the input signals of the units are not computed but rather read from a trace file that was written during the initial simulation of the entire integrated electronic device. The limited simulation is performed on the units, whose physical property metrics violated expected physical property values, using the inputs read from the trace file, in order to verify that the modified description corrects any issues with regard to these physical properties. Other units that did not have their expected physical property values violated are not re-simulated in the second simulation but instead the first simulation is utilized for verification of these other units.

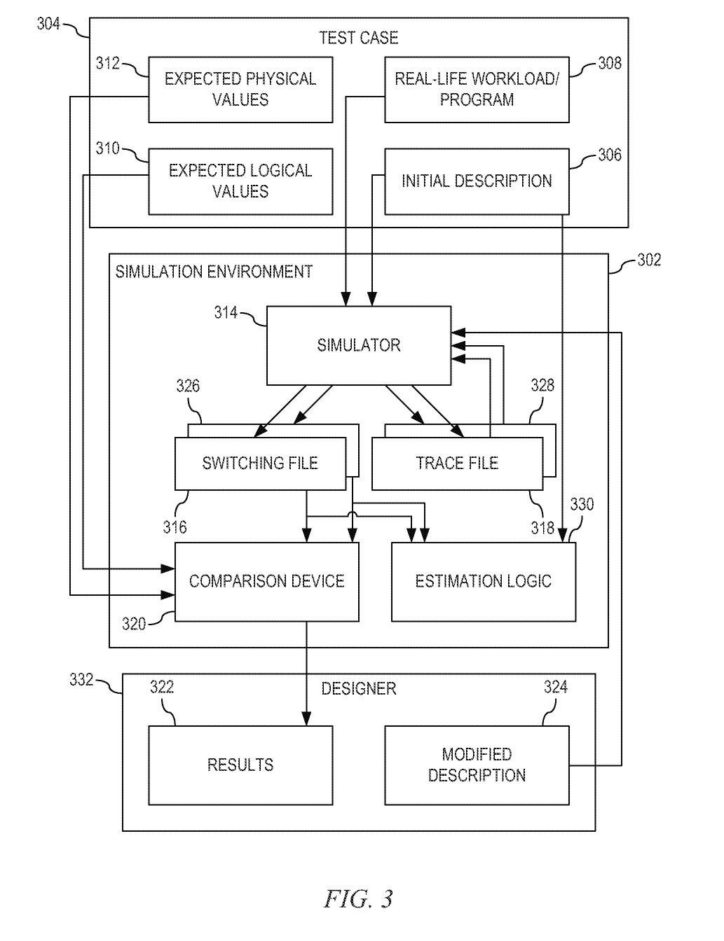

FIG. 3 depicts a functional block diagram of a simulation environment in accordance with an illustrative embodiment. In order to simulate the execution of an integrated electronic device, simulation environment 302 receives test case 304 that comprises initial description 306 of the integrated electronic device, real-life workload/program 308, expected logical values 310, and expected physical values 312. Upon receiving test case 304, simulator 314 simulates the integrated electronic device based on initial description 306 using real-life workload/program 308. Real-life workload/program 308 may be a workload/program designed to measure overall computer system performance for newly designed hardware.

Simulator 314 produces both switching file 316 and trace file 318. Switching file 316 comprises data representative of the number of times each memory element, such as counters, latches, transistors, or the like, in the integrated electronic device switched from 0 to 1 and 1 to 0 for the complete simulation run. That is, switching file 316 may comprise data that describes a switching behavior of the memory elements, i.e., the number of times the memory elements switched, in order to track each unit within the integrated electronic device that consumes energy when the unit's state changes. Trace file 318 comprises data representing the state of each signal in the integrated electronic device for the complete simulation run. That is, the simulation is based on a (simulated) main computer system clock, which is a signal changing from 0 to 1, back to 0, and so on. After every signal change, simulator 314 checks which units within the integrated electronic device design are affected and calculates a new state value of each unit of the integrated electronic device. Simulator 314 writes data representing each state value of every signal to the trace file 318 after every state change.

Comparison device 320 performs a comparison of logical and physical properties of the complete simulation run of the integrated electronic device to expected logical values 310 and expected physical values 312. In comparing the physical properties of the complete simulation run of the integrated electronic device to expected physical values 312, estimation logic 330 uses the data in switching file 316 together with initial description 306 to estimate physical properties, such as power consumption and/or heat production, of each unit in the integrated electronic device by associating a predetermined power consumption value and predetermined heat production value with each switch from 0 to 1 or 1 to 0 in switching file 316 associated with the respective unit to form an estimate of the physical properties of the integrated electronic device. With the estimate of the physical properties of the integrated electronic device determined, comparison device 320 compares the estimated physical properties for each unit to expected physical values 312 and produces results 322 of a power consumption value, i.e. watts used, and a heat production value, i.e. joules used, which may be stored or output to designer 332. For this example, assume that comparison device 320 identifies that, in a particular integrated electronic device design simulation, an instruction sequencer unit (ISU) shows particularly high power consumption. An ISU is used as the circuit element for which a physical property metric violates an associated desired physical property value for purposes of illustration of the operation of the mechanisms of the illustrative embodiments. However, it should be appreciated that the illustrative embodiments are not limited to use with an ISU but can be applied to any circuit element of an integrated electronic device design whose physical property metric(s) is/are determined to violate one or more desired physical property values.

With existing simulation technologies, the designer 332 changes initial description 306 in order to lower power consumption, for example by “clock-gating” memory elements in unused cycles, thus preventing them from switching unnecessarily. In order to verify that the modifications work, a new description of the entire integrated electronic device design would be provided to simulation environment 302 and an entire new simulation would be run. This is usually a time consuming process and typical turn-around times of solutions, or “fixes,” to physical property violations of an integrated electronic device design are rather long due to the simulation of the entire integrated electronic device taking a large amount of computation time.

In accordance with the illustrative embodiment, only the ISU along with any modifications are compiled as modified description 324 which is then the basis for a subsequent limited simulation rather than the entire integrated electronic device design. This allows for much higher simulation speed and turn-around time. However, in the limited simulation, it is impossible to run the real-life workload because the full processor functionality is not available and a determination of the power consumption of a processor design requires exact, cycle-accurate behavior on the input interfaces of the ISU.

Therefore, simulator 314 uses modified description 324 of the ISU, along with a list of input signals of the ISU from trace file 318 from the full integrated electronic device simulation, as the input to the simulation of the ISU. The list of input signals may be identified by the user or determined automatically by simulator 314 based on which circuit elements, e.g., memory elements, are associated with the circuit element whose one or more physical property metrics are determined to have violated its associated one or more desired physical property value, e.g., the ISU in this example.

That is, as the designer implements solutions, or fixes, to the ISU, a record is kept of all changes made to the ISU, which is then sent as part of modified description 324 for use by simulator 314. Afterwards, simulator 314 applies the state values of the input signals from trace file 318 to the simulation of modified description 324 exactly like they were recorded in trace file 318, with respect given to any state values that are inverted or negated based on the redesign as well as any delays that are implemented in the redesign. For example, a preprocess run by simulator 314 extracts initial state values, i.e. 0's and 1's, based on the list of identified input signals of all memory elements of the ISU from trace file 318 and applies these initial states to modified description 324. That is, the determined 0's and 1's are used as the initial inputs to the ISU. An important part of this step is to apply modifications that may result from designer's changes made to generate a new model of the unit. For example, the new model may contain renamed latches. The preprocess obtains all names of memory elements from modified description 324 and initializes the memory elements using state values found in trace file 318, white applying the above-mentioned changes, as appropriate.

Upon receiving modified description 324 of the 1SU along with a list of input signals of the 1SU from trace file 318, simulator 314 simulates the based on modified description 324 using state values from trace file 318 based on the identified list of input signals from the user. Simulator 314 produces new switching file 326 and new trace file 328. Comparison device 320 then performs a comparison of the physical properties of the simulation of the ISU to expected physical values 312. In comparing the physical properties of the complete simulation run of the integrated electronic device to expected physical values 312, estimation logic 330 uses the data in switching file 326 together with modified description 324 to estimate physical properties, such as power consumption and/or heat production, of modified description 324 of the ISU for the input signals from trace file 318 by associating a predetermined power consumption value and predetermined heat production value with each switch from 0 to 1 or 1 to 0 in switching file 316 associated with the respective unit. With the estimate of the physical properties of the integrated electronic device determined, comparison device 320 compares the estimated physical properties to expected physical values 312. That is, comparison device 320 determines whether the improved ISU actually lowers the power consumption. If not, designer 332 of the ISU may make another try at fixing the problem and quickly rerun the test in simulation environment 302.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) Or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

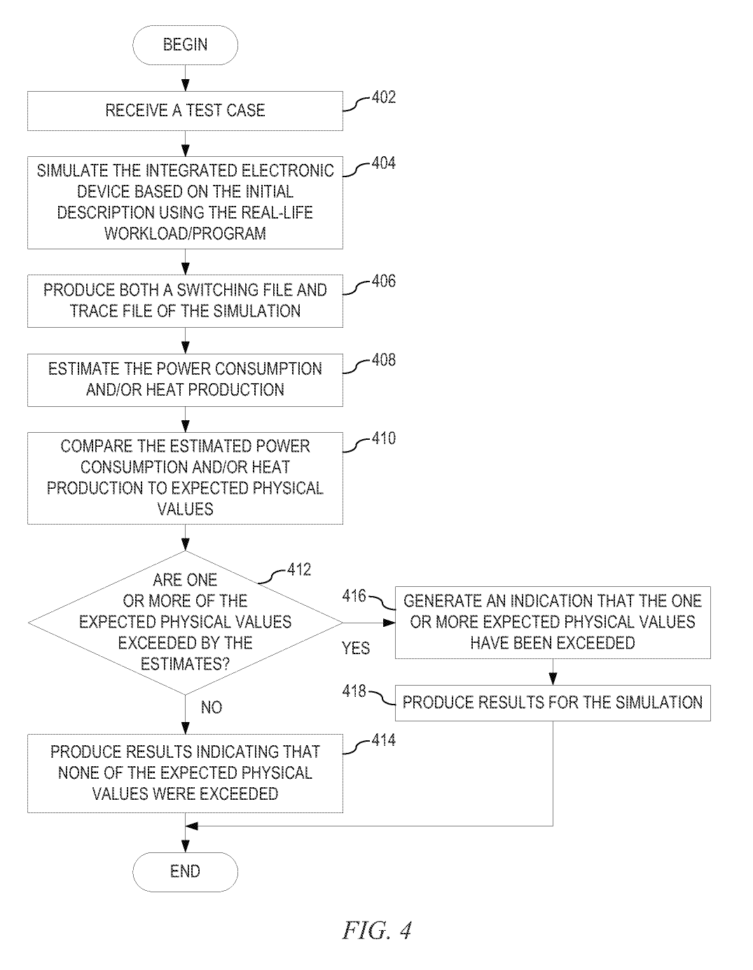

FIG. 4 depicts a flow diagram of the process performed by a simulation mechanism in simulation of the execution of an integrated electronic device in accordance with an illustrative embodiment. As the operation begins, the simulation mechanism receives a test case that comprises an initial description of the integrated electronic device, a real-life workload/program, expected logical values, and expected physical values (step 402). Upon receiving the test case, a simulator in the simulation mechanism simulates the integrated electronic device based on the initial description using the real-life workload/program (step 404). The simulator produces both a switching file and trace file of the simulation (step 406). Estimation logic in the simulation mechanism then uses data in the switching file together with the initial description to estimate physical properties, such as power consumption and/or heat production, of the initial description of the integrated electronic device for the given real-life workload/program (step 408).

With the estimate of the physical properties of the integrated electronic device determined, the comparison device compares the estimated physical properties to the expected physical values (step 410). The comparison device determines whether one or more of the expected physical values are exceeded by the estimates (step 412). If at step 412 none of the expected physical values are exceeded, then the comparison device produces results indicating that none of the expected physical values were exceeded (step 414), with the operation terminating thereafter. If at step 412 one or more of the expected physical values are exceeded, then the comparison device generates an indication that the one or more expected physical values have been exceeded (step 416) as well as produces results for the simulation (step 418), with the operation terminating thereafter.

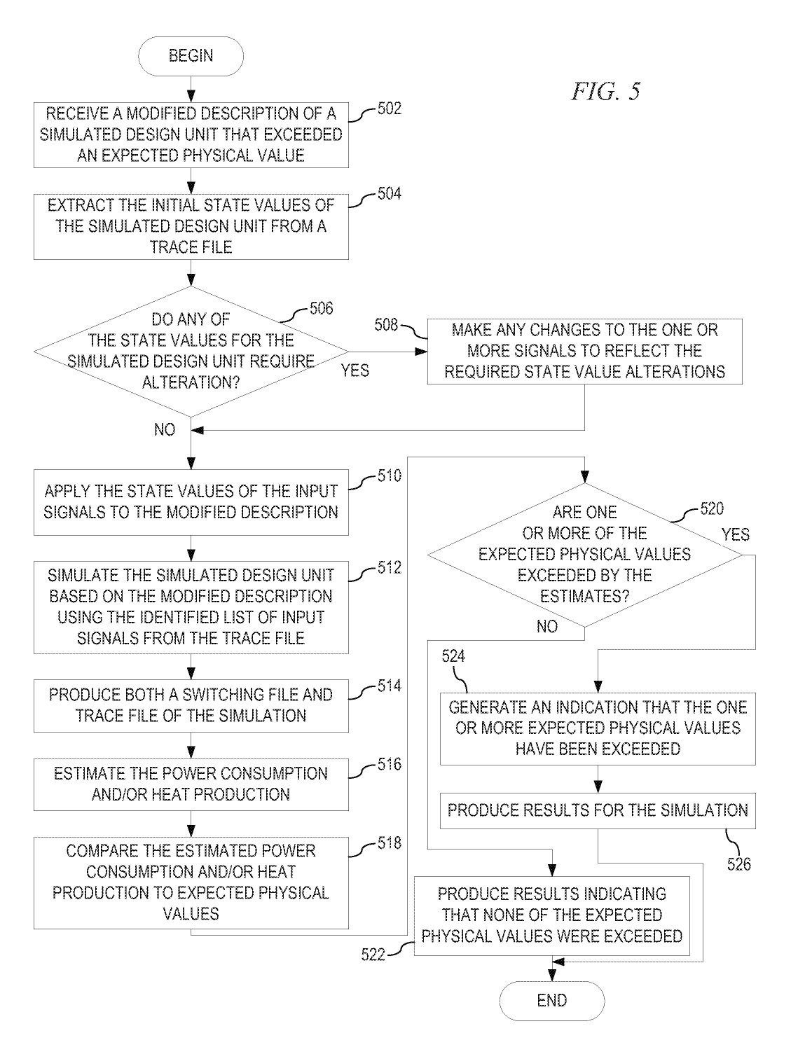

FIG. 5 depicts a flow diagram of the process performed by a simulation mechanism in simulation of the re-execution of a unit in a plurality of units within an integrated electronic device in accordance with an illustrative embodiment. As the operation begins, the simulation mechanism receives a modified description of a unit in the plurality of units within an integrated electronic device that exceeded an expected physical value (step 502). A simulator in the simulation mechanism extracts the initial state values of all memory elements associated with the unit from a trace file generated during the initial simulation of the entire integrated electronic device (step 504).

The simulator then determines whether any of the ate values for the unit require alteration, such as being negated or delayed (step 506). If at step 506 one or more of the state values require alteration, then the simulator makes any changes to the one or more signals to reflect the required state value change (step 508). From step 508 or if at step 506 none of the signals require alteration, the simulator applies the values of the input signals to the modified description (step 510).

The simulator then simulates the unit based on the modified description using the identified list of input signals from the trace file (step 512). The simulator produces both a new switching file and new trace file of the simulation of the unit (step 514). Estimation logic in the simulation mechanism then uses the data in the new switching file together with the modified description to estimate physical properties, such as power consumption and/or heat production, of the modified description of the unit for the input signals from the trace file (step 516).

With the estimate of the physical properties of the integrated electronic device determined, the comparison device compares the estimated physical properties to the expected physical values (step 518). The comparison device determines whether one or more of the expected physical values are exceeded by the estimates (step 520). If at step 520 none of the expected physical values are exceeded, then the comparison device produces results indicating that none of the expected physical values were exceeded (step 522), with the operation terminating thereafter. If at step 520 one or more of the expected physical values are exceeded, then the comparison device generates an indication that the one or more expected physical values have been exceeded (step 524) as well as produces results for the simulation (step 526), with the operation terminating thereafter.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the Hock diagrams and/or flowchart illustration, can be implemented by special purpose hardware-based systems that perform the specified functions or acts, or combinations of special purpose hardware and computer instructions.

Thus, the illustrative embodiments provide mechanisms for reducing the time and resource requirements of the verification for problem fixes in integrated electronic devices. Integrated electronic devices that comprise several units with signals connecting the units have one or more non-functional properties which may or may not be related to the value of the signals. An integrated electronic device may be simulated using a first version of a formal description of the integrated electronic device such that values are computed for the one or more non-functional properties, which are then reported and/or stored, and then are compared with expected values. If after the simulation, one or more units have one or more non-functional properties that fail to meet the expected value, a second version of the formal description is provided. A second simulation is then performed only for those units for which the comparison failed. During this second simulation, the values for the input signals of the units are not computed but read from the file written during the first simulation run in order to verify that the second version corrects any issues with the first version.

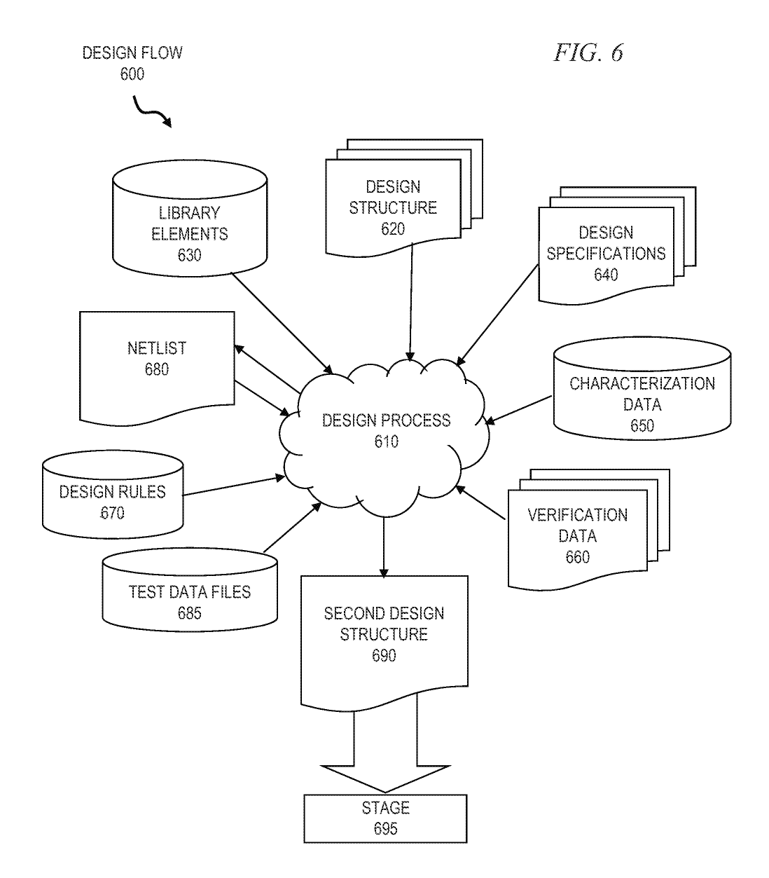

FIG. 6 shows a block diagram of an exemplary design flow 600 used, for example, in semiconductor design, manufacturing, and/or test. Design flow 600 may vary depending on the type of IC being designed. For example, a design flow 600 for building an application specific IC (ASIC) may differ from a design flow 600 for designing a standard component. Design structure 620 is preferably an input to a design process 610 and may come from an IP provider, a core developer, or other design company or may be generated by the operator of the design flow, or from other sources. Design structure 620 comprises an embodiment of the invention as shown in FIGS. 3-5 in the form of schematics or HDL, a hardware-description language (e.g., Verilog, VHDL, C, etc.). Design structure 620 may be contained on one or more machine readable medium. For example, design structure 620 may be a text file or a graphical representation of an embodiment of the invention as shown in FIGS. 3-5. Design process 610 preferably synthesizes (or translates) an embodiment of the invention as shown in FIGS. 3-5 into a netlist 680, where netlist 680 is, for example, a list of wires, transistors, logic gates, control circuits, I/O, models, etc. that describes the connections to other elements and circuits in an integrated circuit design and recorded on at least one of machine readable medium. This may be an iterative process in which netlist 680 is resynthesized one or more times depending on design specifications and parameters for the circuit.

Design process 610 may include using a variety of inputs; for example, inputs from library elements 630 which may house a set of commonly used elements, circuits, and devices, including models, layouts, and symbolic representations, for a given manufacturing technology (e.g., different technology nodes, 32 nm, 45 nm, 90 nm, etc.), design specifications 640, characterization data 650, verification data 660, design rules 670, and test data files 685 (which may include test patterns and other testing information). Design process 610 may further include, for example, standard circuit design processes such as timing analysis, verification, design rule checking, place and route operations, etc. One of ordinary skill in the art of integrated circuit design can appreciate the extent of possible electronic design automation tools and applications used in design process 610 without deviating from the scope and spirit of the invention. The design structure of the invention is not limited to any specific design flow.

Design process 610 (preferably translates an embodiment of the invention as shown in FIGS. 3-5, along with any additional integrated circuit design or data (if applicable), into a second design structure 690. Design structure 690 resides on a storage medium in a data format used for the exchange of layout data of integrated circuits (e.g. information stored in a GDSII (GDS2), GL1, OASIS, or any other suitable format for storing such design structures). Design structure 690 may comprise information such as, for example, test data files, design content files, manufacturing data., layout parameters, wires, levels of metal, vias, shapes, data for routing through the manufacturing line, and any other data required by a semiconductor manufacturer to produce an embodiment of the invention as shown in FIGS. 3-5. Design structure 690 may then proceed to a stage 695 where, for example, design structure 690: proceeds to tape-out, is released to manufacturing, is released to a mask house, is sent to another design house, is sent back to the customer, etc.

As noted above, it should be appreciated that the illustrative embodiments may take the form of an entirety hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, hulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for verifying design modifications to a simulation design unit included within a simulation model of an integrated electronic device, the method comprising:
receiving a modified description of the simulation design unit that failed to meet an expected physical property value during an initial simulation of the entire integrated electronic device;
executing a simulation of the simulation design unit using a list of identified input signals from a trace file, wherein the trace file is generated during the initial simulation of the entire integrated electronic device, and wherein the trace file indicates state values for the list of identified input signals;
determining whether the simulation of the simulation design unit fails to meet the expected physical property value; and
responsive to the simulation of the simulation design unit meeting the expected physical property value, generating an indication that modifications made to an initial description of the simulation design unit are successful.

2. The method of claim 1, wherein initial state values of memory elements used by the simulation design unit is identified by the method comprising:
extracting the initial state values from the trace file for every memory element associated with the simulation design unit based on the list of identified input signals.

3. The method of claim 1, wherein one or more of the state values require alteration and wherein the alteration is performed by the method comprising:
determining whether any input signal in the list of identified input signals for the simulation design unit requires state value alteration based on modifications made to the initial description; and
responsive to one or more of the input signals in the list of identified input signals requiring state value alteration, applying a change to the one or more input signals to reflect the required state value alteration.

4. The method of claim 3, wherein the change is at least one of the state values being negated.

5. The method of claim 3, wherein the change is at least one of the state values being delayed.

6. The method of claim 3, wherein the change is an element within the modified description that has been renamed with respect to a previous description.

7. The method of claim 1, wherein the determination of whether the simulation of the simulation design unit fails to meet the expected physical property value comprises:
generating a switching file and the trace file of the simulation of the simulation design unit;
estimating physical properties of the simulation design unit using data in the switching file together and the modified description of the simulation design unit; and
comparing the estimated physical properties to a set of expected physical values.

8. The method of claim 6, wherein the switching file specifies logic switching frequency of storage elements associated with the simulation design unit.

9. A computer program product comprising a computer readable storage medium having a computer readable program stored therein, wherein the computer readable program, when executed on a computing device, causes the computing device to:
receive a modified description of the simulation design unit that failed to meet an expected physical property value during an initial simulation of the entire integrated electronic device;
execute a simulation of the simulation design unit using a list of identified input signals from a trace file, wherein the trace file is generated during the initial simulation of the entire integrated electronic device, and wherein the trace file indicates state values for the list of identified input signals;
determine whether the simulation of the simulation design unit fails to meet the expected physical property value; and
responsive to the simulation of the simulation design unit meeting the expected physical property value, generate an indication that modifications made to an initial description of the simulation design unit are successful.

10. The computer program product of claim 9, wherein the computer readable program identifies the initial state values of memory elements used by the simulation design unit by causing the computing device to:
extract the initial state values from the trace file for every memory element associated with the simulation design unit based on the list of identified input signals.

11. The computer program product of claim 9, wherein one or more of the state values require alteration and wherein the computer readable program performs the alteration by causing the computing device to:
determine whether any input signal in the list of identified input signals for the simulation design unit requires state value alteration based on modifications made to the initial description; and
responsive to one or more of the input signals in the list of identified input signals requiring state value alteration, apply a change to the one or more input signals to reflect the required state value alteration.

12. The computer program product of claim 11, wherein the change is an element within the modified description that has been renamed with respect to a previous description.

13. The computer program product of claim 9, wherein the computer readable program determines whether the simulation of the simulation design unit fails to meet the expected physical property value by causing the computing device to:
generate a switching file and the trace file of the simulation of the simulation design unit;
estimate physical properties of the simulation design unit using data in the switching file together and the modified description of the simulation design unit; and
compare the estimated physical properties to a set of expected physical values.

14. The computer program product of claim 13, wherein the switching file specifies logic switching frequency of storage elements associated with the simulation design unit.

15. An apparatus, comprising:
a processor; and
a memory coupled to the processor, wherein the memory comprises instructions which, when executed by the processor, cause the processor to:
receive a modified description of the simulation design unit that failed to meet an expected physical property value during an initial simulation of the entire integrated electronic device;
execute a simulation of the simulation design unit using a list of identified input signals from a trace file, wherein the trace file is generated during the initial simulation of the entire integrated electronic device, and wherein the trace file indicates state values for the list of identified input signals;
determine whether the simulation of the simulation design unit fails to meet the expected physical property value; and
responsive to the simulation of the simulation design unit meeting the expected physical property value, generate an indication that modifications made to an initial description of the simulation design unit are successful.

16. The apparatus of claim 15, wherein the instructions identify the initial state values of memory elements used by the simulation design unit by causing the processor to:
extract the initial state values from the trace file for every memory element associated with the simulation design unit based on the list of identified input signals.

17. The apparatus of claim 15, wherein one or more of the state values require alteration and wherein the instructions perform the alteration by causing the processor to:
determine whether any input signal in the list of identified input signals for the simulation design unit requires state value alteration based on modifications made to the initial description; and
responsive to one or more of the input signals in the list of identified input signals requiring state value alteration, apply a change to the one or more input signals to reflect the required state value alteration.

18. The apparatus of claim 17, wherein the change is an element within the modified description that has been renamed with respect to a previous description.

19. The apparatus of claim 15, wherein the instructions determine whether the simulation of the simulation design unit fails to meet the expected physical property value by causing the processor to:
generate a switching file and the trace file of the simulation of the simulation design unit;
estimate physical properties of the simulation design unit using data in the switching file together and the modified description of the simulation design unit; and
compare the estimated physical properties to a set of expected physical values.

20. The apparatus of claim 19, wherein the switching file specifies logic switching frequency of storage elements associated with the simulation design unit.
